(19) United States
(12) Patent Application Publication
(10) Pub. No.: US 2024/0217618 A1
(43) Pub. Date: Jul. 4, 2024

(54) Drive Assembly

(71) Applicant: Robert Bosch GmbH, Stuttgart (DE)

(72) Inventors: Julien Hassler, Kusterdingen (DE); Rainer Mast, Bondorf (DE); Quoc-Dat Nguyen, Neckartenzlingen (DE); Benjamin Bertsch, Lichtenstein (DE); Julian Binder, Wannweil (DE)

(21) Appl. No.: 18/558,893

(22) PCT Filed: May 13, 2022
(86) PCT No.: PCT/EP2022/063079

§ 371 Date: Nov. 3, 2023

(30) Foreign Application Priority Data
May 17, 2021 (DE) 10 2021 204 956.7
Apr. 29, 2022 (DE) 10 2022 204 224.7

(51) Int. Cl. B62M 6/55; B62D 65/02

(52) U.S. Cl. CPC B62M 6/55; B62D 65/02

(57) ABSTRACT

A drive assembly of a vehicle, in particular a vehicle which is operated using muscle power and/or a motor includes a drive unit, a frame interface, and at least one holding element. The frame interface is L-shaped and has a base and a lateral wall. The drive unit is screwed to the base of the L-shaped frame interface via a fixed bearing assembly. The holding element is screwed to the lateral wall of the L-shaped frame interface and to the drive unit via a respective floating bearing assembly in each case.

### PRIOR ART

The present invention relates to a drive assembly, a vehicle comprising the drive assembly, and a method for producing a drive assembly.

Drive assemblies of vehicles, for example electric bicycles, are known, wherein a drive unit is screwed to a vehicle frame of a vehicle. The drive unit is often arranged partially between two walls of the vehicle frame. For the connection, an indirect screwing of the vehicle frame and the drive unit is often carried out via pieces of sheet metal, which are arranged on both sides of the drive unit. Typically, there is a gap between the drive unit and the second wall to be screwed. To bridge this gap, for example, one of the holding sheets can be deformed until it abuts the wall. However, this can have an adverse effect on the mechanical stress and the tightness of the drive assembly.

### DISCLOSURE OF THE INVENTION

By contrast, the drive assembly according to the invention having the features of claim 1 is characterized in that a particularly simple and stable construction can be provided, which is suitable for adjusting optimal stress conditions on a drive unit. This is achieved by a drive assembly comprising a drive unit, a frame interface, and at least one holding element. The frame interface can be shaped like a pot. The frame interface has a base and a lateral wall. The base is in particular arranged on the output side of the drive unit. In particular, a receiving space of the frame interface is defined by the base and lateral wall. Preferably, the receiving space opens on a side opposite the base. The drive unit is preferably arranged at least partially within the receiving space of the frame interface and abuts the base. Preferably, at least one holding region of the drive unit is arranged between the holding element and the base. The holding element is screwed to both the lateral wall and the drive unit.

In other words, the holding element is located on a side of the holding region of the drive unit opposite the base. Preferably, the holding element is arranged on a front side of the lateral wall. The drive unit is at least partially held within the receiving space by the screwing of the holding element. In particular, the holding element is screwed from one side, in particular the open side of the pot-shaped frame interface, to the holding region of the drive unit and to the frame interface. As a result, a particularly easy assembly of the drive assembly can be provided. In addition, the stress conditions of the drive unit can be adjusted particularly simply and specifically by adjusting a gap between the holding element and the drive unit, or between the holding element and the lateral wall. By means of a pot-shaped construction of the frame interface, a mechanical protection of the drive unit can also be provided, for example, against rock impacts, mechanical contacts, or other environmental factors. In addition, a particularly high rigidity of the entire assembly can be provided by a pot-shaped frame interface. For example, a particularly large contact region with the drive unit can be provided by the lateral wall, whereby a particularly good distribution of the mechanical stresses can be enabled. For example, the stresses transferred from a vehicle frame to the drive unit can thereby be evenly distributed to the drive unit, for example, during strong braking maneuvers or the like.

The drive unit preferably has a housing, a bottom bracket axle, and, in particular within the housing, a motor and/or a transmission.

Preferably, an L-shaped assembly of the lateral wall and the base is considered to be the pot-shaped construction of the frame interface. In particular, the lateral wall and base are arranged at a right angle to one another. Preferably, the base can be formed continuously. Alternatively, the base can have one or more recesses through which, for example, portions of the drive unit or other components can protrude.

Preferably, the drive assembly has precisely two holding elements in order to enable a particularly simple and reliable connection of the drive unit and frame interface.

The subclaims relate to preferred further developments of the invention.

In particular, the base of the frame interface is arranged on an output side of the drive unit and is substantially orthogonal to a bottom bracket axle of the drive unit, and the lateral wall is arranged substantially perpendicular to the base.

The drive unit is additionally screwed to the base via a fixed bearing assembly. In particular, the fixed bearing assembly is formed in that the base is screwed to at least one threaded bolt, preferably to a threaded screw, to at least one thread, preferably to a threaded sleeve, of a housing of the drive unit. In particular, the drive unit and the base are screwed directly by means of at least one screw. Preferably, the at least one screw is screwed into the drive unit from outside the frame interface through an opening of the base. As a result, a particularly stable connection of the drive unit and the frame interface can be provided.

The floating bearing assembly is preferably formed in that the holding element is an elastically deformable, plate-shaped element.

Particularly preferably, the drive assembly is configured such that at least the holding region of the drive unit between the holding element and the base is predefinedly stressed by tension or pressure when the drive assembly is fully screwed. In particular, a state in which all screws are screwed to a stop with a predefined target torque is considered to be the fully screwed state. The tensile stress or compressive stress is preferably adjusted in that the holding element is correspondingly adapted to a tolerance position of the holding region of the drive unit and frame interface such that, after screwing, the corresponding predefined tensile stress or compressive stress is present. Alternatively or additionally preferably, the tensile stress or compression stress is adjusted by specially adapted support points for the drive unit on the base of the frame interface. Preferably, a tolerance position of the drive assembly is adjusted for the compressive stress such that the holding element abuts the holding region of the drive unit before screwing, and at the same time a gap is present between the holding element and the lateral wall of the frame interface. By fully screwing, this gap is closed and at least the holding region of the drive unit is clamped by pressure between the holding element and the base. Alternatively, for the tensile stress, the tolerance position of the drive assembly is adjusted such that the holding element abuts the lateral wall before screwing, and at the same time there is a gap between the holding element and the holding region of the drive unit. By bolting, this gap is closed and at least the holding region of the drive unit is stressed by tension between the base and the holding element. Thus, the optimal desired stress state of the drive unit can be adjusted in a particularly straightforward manner.

Preferably, the lateral wall completely surrounds the receiving space in the circumferential direction. That is to say, the receiving space is circumferentially fully closed by the lateral wall. This allows for a particularly good mechanical protection of the drive unit against environmental factors and a particularly uniform stress distribution between the drive unit and the frame interface.

Further preferably, the lateral wall has at least one recess, such that the receiving space is laterally open. Preferably, the recess extends over at least 20%, preferably a maximum of 80%, of the circumference of the lateral wall. Preferably, the recess extends over the entire height of the lateral wall. The recess in the lateral wall can provide a particularly inexpensive frame interface of low weight. In addition, the recess allows for better accessibility of the drive unit.

Furthermore, the holding element is preferably a planar piece of sheet metal. A planar piece of sheet metal as a holding element allows for a particularly simple and cost-effective design of the low-weight drive assembly. It is particularly advantageous when the drive assembly has two holding elements, each of which are flat pieces of sheet metal. Preferably, each sheet is screwed to the lateral wall by means of exactly one screw and to the holding region of the drive unit by means of two screws.

Particularly preferably, the holding element is a stepped sheet having two planar sheet portions. The two planar sheet portions are arranged with a predefined offset parallel to one another. The offset of the two sheet portions is considered in the unscrewed state of the holding element, i.e., without mechanical stress on the holding element. Preferably, the offset can change by screwing, for example by bridging a gap by means of the holding element. Preferably, the first flat sheet portion is screwed to the holding region of the drive unit, and the second flat sheet portion is screwed to the lateral wall. By means of the stepped piece of sheet metal, the tensile stress or the compressive stress of the holding region of the drive unit can be adjusted particularly simply and purposefully, in particular by adjusting the offset accordingly.

Furthermore, preferably, the holding element is a lid that abuts an entire front face of the lateral wall of the frame interface. Preferably, the lid thus covers substantially the entire holding space on its open side. Preferably, the lid is similar to the base, and in particular, together with the preferably pot-shaped frame interface forms a substantially closed receiving space. For example, the lid can have recesses through which portions of the drive unit or further elements can protrude. For example, the lid can be formed from plastic, or alternatively from metal, for example aluminum. The lid allows for particularly good protection of the drive unit against environmental factors.

Particularly preferably, the lid has at least one opening, and per opening has an elastomeric element and a sleeve. The elastomeric element and the sleeve are arranged within the opening and screwed to the drive unit by means of a screw. The screw connection is such that the sleeve is pressed against the elastomeric element and the elastomeric element against the drive unit by means of the screw. In particular, in an end state, the sleeve can be in contact with the drive unit, preferably such that the elastomeric element is in a parallel force connection. The elastomeric element can enable a particularly reliable and robust screw connection, for example because vibrations or impacts can be dampened by a certain resiliency of the elastomeric element, in order to avoid damage. Advantageously, the elastomeric element also allows for a tolerance compensation of the screwing, preferably by radially flaring the elastomeric element by means of the sleeve and abutting against an inner wall of the opening. This fixes the elastomeric element axially and radially in the opening, thereby also fixing the lid and the drive unit relative to one another.

The invention furthermore leads to a vehicle, in particular a vehicle which is operated using muscle power and/or a motor, preferably an electric bicycle, which has the described drive assembly.

Preferably, the vehicle has a chassis, wherein the frame interface is an integral component of the chassis. The frame interface is preferably connected to a lower tube and/or to a seat tube and/or to chain struts of the vehicle frame, preferably respectively by means of a welded connection or a screwed connection or an adhesive connection. In particular, the frame interface is arranged such that a bottom bracket axle of the vehicle passes through the drive unit and the frame interface. Preferably, the frame interface is arranged such that the bottom bracket axle is substantially perpendicular to the base of the frame interface. By allowing the frame interface to be integrated into the chassis, a particularly simple design can be made possible, which allows a robust and well-protected assembly of the drive unit. In addition, a particularly simple assembly of the drive unit can be enabled, because accessibility of the receiving space is only required from one side.

Particularly preferably, the base of the frame interface is arranged on the output side of the drive unit. That is to say, when the vehicle is viewed in a direction of travel of the vehicle, the base of the frame interface is arranged on the side of the chassis on which the chainring is located. In addition to a particularly simple accessibility of the frame interface for the assembly of the drive unit, this enables an optimal transmission of power in the region of the drive assembly during operation of the vehicle. Due to the chain force, the highest force acts on the output side of the drive assembly. Because the base of the preferably pot-shaped frame interface is located here, this force can be distributed particularly evenly. If the drive unit is preferably screwed directly to the base, for example at a plurality of screw points distributed throughout the base, a particularly direct transmission of force between the drive unit and the frame interface can thus be achieved.

Furthermore, preferably, the vehicle further has a spring-loaded chainstay that is connected to the frame interface in an articulated manner by means of a hinge. The hinge is integrated into the lateral wall of the frame interface. A particularly advantageous stress distribution of the forces acting on the drive assembly can thus also be achieved. In addition, the integration of the hinge into the lateral wall allows for an assembly of a pivot axis about which the chainstay is pivotable relative to a main frame of the vehicle frame, particularly close to a bottom bracket axle, whereby improved kinematics of the vehicle can be provided.

Furthermore, the invention leads to a method for producing a drive assembly of a vehicle, preferably the drive assembly described above. The method has the following steps:
arranging a drive unit in a receiving space of a pot-shaped frame interface such that the drive unit abuts a base of the frame interface,
providing at least one holding element, and
screwing the holding element to a lateral wall of the frame interface and to the drive unit.
   The holding element is screwed to the drive unit and the lateral wall such that, in a fully screwed state, the drive unit between the holding element and the base of the frame interface is stressed by tension or pressure. The method is thus characterized by a particularly simple, fast, and cost-effective manufacturability of the drive assembly, wherein optimal stress conditions can be enabled on the drive unit and the frame interface.

Preferably, the method further comprises the following steps:
producing the frame interface by casting, in particular die-casting, preferably from aluminum or an aluminum alloy,
generating screw openings in the frame interface, and
generating support points on the base of the frame interface.
   The generation of the screw openings and support points is carried out by means of machining, preferably by means of drilling and/or milling, and preferably in a single chucking. Due to the fact that both the screw openings and the support points are produced by means of machining, particularly high accuracies, i.e., low position tolerances, can be produced. In particular, when these are generated in a single chucking, particularly low position tolerances relative to one another can be achieved. The drive unit can thus be positioned and screwed particularly precisely to the frame interface.

### BRIEF DESCRIPTION OF THE DRAWINGS

The invention is described in the following with reference to exemplary embodiments in conjunction with the figures. In the figures, functionally equivalent components are identified with the same respective reference numerals. The figures show:

FIG. 1 a sectional view of a drive assembly according to a first exemplary embodiment of the invention,

FIG. 2 a detail of a side view of a vehicle with the drive assembly of FIG. 1,

FIG. 3 a detail view of a frame interface of the drive assembly of FIG. 1,

FIG. 4 a detail view of a holding element of a drive assembly according to a second exemplary embodiment of the invention,

FIG. 5 a detail of a sectional view of the drive assembly according to the second exemplary embodiment of the invention,

FIG. 6 a detail of a further sectional view of the drive assembly of FIG. 5,

FIG. 7 a detail of a side view of a vehicle having a drive assembly according to a third exemplary embodiment of the invention, and

FIG. 8 a sectional view of a drive assembly according to a fourth exemplary embodiment of the invention,

FIG. 9 a schematic view of a vehicle in the form of a vehicle which is operated using muscle power and/or a motor, preferably an electric bicycle.

### PREFERRED EMBODIMENTS OF THE INVENTION

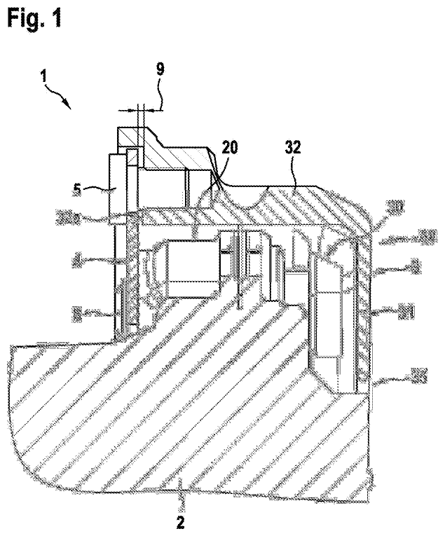

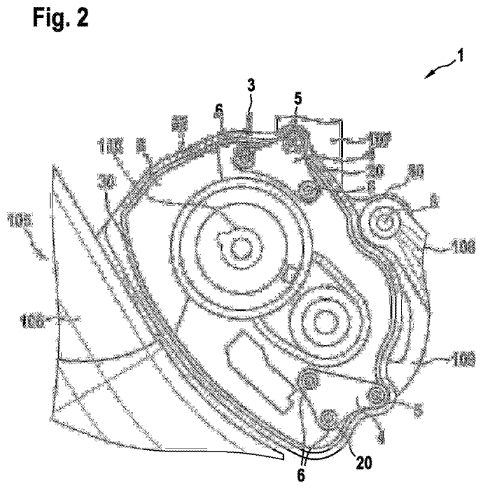

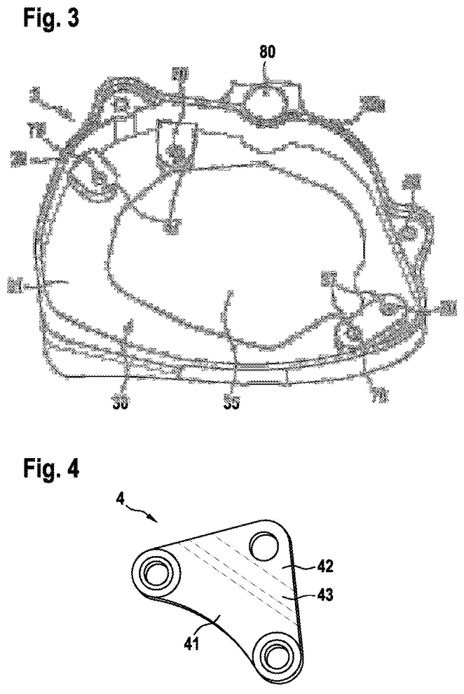

FIG. 1 shows a sectional view of a drive assembly 1 according to a first exemplary embodiment of the invention. The drive assembly 1 is part of a vehicle (not shown), which is an electric bicycle. The drive assembly 1 of the first exemplary embodiment is shown in further views in FIGS. 2 and 3.

The drive assembly 1 has a drive unit 2 comprising a motor and/or a transmission. Furthermore, the drive assembly 1 has a frame interface 3. The frame interface 3 is preferably shaped like a pot and has a base 31 and a lateral wall 32, which are arranged in an L-shape. For example, the base 31 and the lateral wall 32 define a receiving space 30 within which the drive unit 2 is partially arranged. The drive unit 2 abuts the base 31 at a plurality of support points 37 (cf. FIG. 3; not shown in FIG. 1) of the base 31.

As can be seen in FIG. 1, as well as in FIG. 3, the base 31 has a recess 35 through which a part of the drive unit 2 can at least partially project.

The drive assembly 1 further has a holding element 4, which is configured as a planar piece of sheet metal. The holding element 4 is screwed to the lateral wall 32 of the frame interface 3 by means of a first screw 5, and is also screwed to the drive unit 2 by means of two second screws 6 (cf. FIG. 2). As can be seen in FIGS. 1 and 2, the two screws 5, 6 are screwed into the lateral wall 32 and the drive unit 2 from the same side through the holding element 4.

Additionally, the drive unit 2 is screwed directly to the base 31 of the frame interface 3 from an opposite side. This screwing is not visible in FIGS. 1 and 2, but the corresponding bores 70 of the base 31, through which the associated screws are screwed into the drive unit 2, can be seen in FIG. 3.

FIG. 1 shows a state of the drive assembly 1 in which is not yet fully screwed. That is to say, the screws 5, 6 are not yet tightened to a stop at a predetermined target torque, in the state shown in FIG. 1. As can be seen in FIG. 1, there is a gap 9 between the holding element and a front face 32 a of the lateral wall. For example, the gap 9 can result from manufacturing tolerances or can have been specifically generated during the production of the frame interface 3.

If the screws 5, 6 are tightened fully to the predetermined target torque, the holding element 4 is deformed until it abuts the front face 32a of the lateral wall 32 and is thus stressed by bending. A corresponding bending force is thereby applied to the holding region 20 of the drive unit 2 so that the holding region 20 between the holding element 4 and the base 31 is stressed by pressure. By applying pressure to the drive unit 2, a particularly favorable mechanical fastening can be achieved for a long lifetime of the drive unit 2. In addition, the compressive stress has a favorable effect on a reliable sealing of the drive unit 2, for example when it has a housing that can be formed from housing halves that are screwed together.

As can be seen in FIG. 2, the lateral wall 32 circumferentially completely surrounds the drive unit 2. A particularly good protection of the drive unit 2 can thus be achieved. Furthermore, the bottom bracket axle 110 is shown. For example, the frame interface prevents direct mechanical effects on the drive unit 2, such as by rock impacts or bouncing on objects.

FIG. 2 also shows the joining of the frame interface 3 into the vehicle frame 105 of the electric bicycle. The frame interface 3 and the drive unit 2 are located in the region of a bottom bracket (110) of the electric bicycle. The frame interface 3 is connected to a lower tube 106 and a seat strut 107 of the vehicle frame 105 by means of a welded connection.

Furthermore, the frame interface 3 has a hinge 8 which is integrated into an opening 80 within the lateral wall 32. By means of the hinge 8, a chain strut 108 of a spring-loaded chainstay (not shown) of the electric bicycle is hingedly connected to the frame interface 3.

The frame interface 3 is aligned on the chassis 105 such that the base 31 (not visible in FIG. 2) is arranged on the output side (60) of the drive unit 2, i.e., closer to a chainring 109 than to the drive unit 2. The frame interface 3 opens on a side facing away from the chainring 109.

The frame interface 3, which is shown in detail in a perspective view in FIG. 3, is preferably a casting part formed from aluminum or an aluminum alloy. The support points 37 for the drive unit 2 are produced by milling after casting of the frame interface 3. Directly in the same chucking, bores 50, 70 can be drilled for all screws 5 as well as the opening 80 for the joint 8, wherein a particularly high accuracy, especially relative to one another, can be enabled for all elements produced by machining.

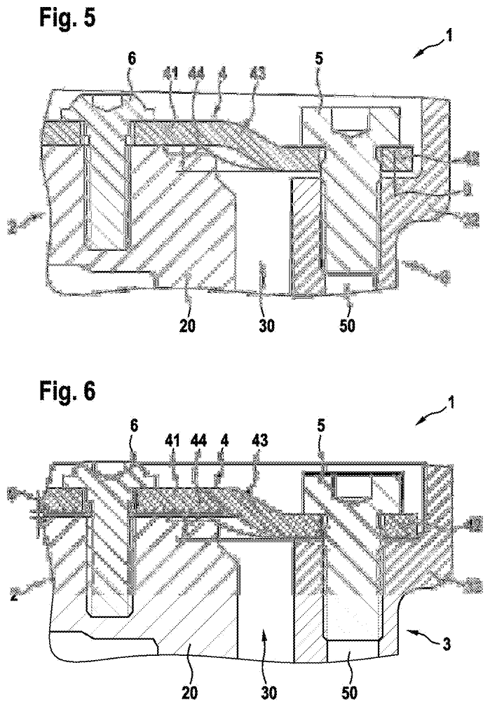

FIG. 4 shows a detail view of a holding element 4 of a drive assembly 1 according to a second exemplary embodiment of the invention. The drive assembly 1 of the second exemplary embodiment with variants of the holding element 4 shown in FIG. 4 is shown in FIGS. 5 and 6. The second exemplary embodiment substantially corresponds to the first exemplary embodiment of FIGS. 1 to 3, with the difference of an alternative holding element 4. In the second exemplary embodiment, the holding element 4 is a stepped piece of sheet metal having two planar sheet portions 41, 42. The two sheet portions 41, 42 are arranged parallel to one another and with a predefined offset 44 to one another in an unscrewed state, as shown in FIG. 4.

The offset 44 is configured so that, in the fully screwed state of the drive assembly 1, there is either a compressive stress or a tensile stress of the holding region 20 of the drive unit 2. The offset 44 is preferably dimensioned as a function of a tolerance position of the drive unit 2 and the frame interface 3. The two variants are shown in FIGS. 5 and 6.

FIG. 5 shows a holding element 4 with an offset 44, which is configured so that, in the unscrewed state and when a first sheet portion 41 of the holding element 4 abuts the holding region 20 of the drive unit 2, there is a gap 9 between the second sheet portion 42 and the lateral wall 32 of the frame interface 3. If the screws 5, 6 are fully tightened, the holding element 2 is bent until the second sheet portion 42 abuts the lateral wall 32. The holding region 20 is thereby stressed by pressure via the holding element 4 and between the holding element 4 and the base 31.

FIG. 6 analogously shows an alternative configuration of the holding element 4, wherein the offset 44 is configured such that, in the unscrewed state, a gap 9 is present between the first sheet portion 41 and the holding region 20. Because, in this state, the second holding region 42 already abuts the lateral wall 32, a full tightening of the screws 5, 6 causes the holding region 20 of the drive unit 2 to be stressed by tension.

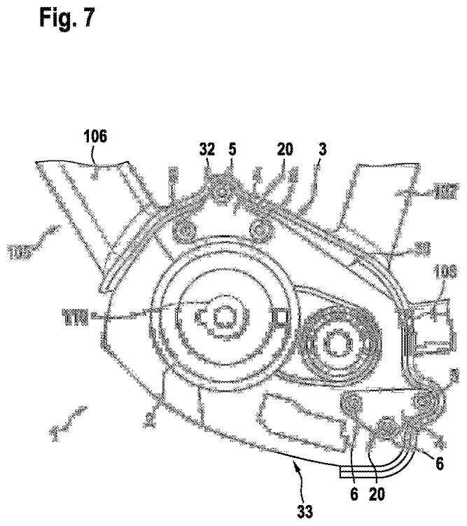

FIG. 7 shows a detail of a side view of a vehicle having a drive assembly 1 according to a third exemplary embodiment of the invention. The third exemplary embodiment substantially corresponds to the first exemplary embodiment of FIGS. 1 to 3, with the difference that the frame interface 3 is configured so as to open on the side. In detail, in the third exemplary embodiment, the lateral wall 31 of the frame interface 3 has a recess 33, which extends over about 30% of a circumference of the lateral wall 31. The recess 33 is located on a vertically lower side and in the direction of travel A of the front side of the frame interface 3. The recess 33 allows for a particularly simple, inexpensive, and weight-saving construction of the frame interface 3. In addition, the recess 33 allows for a particularly good accessibility of the drive unit 2.

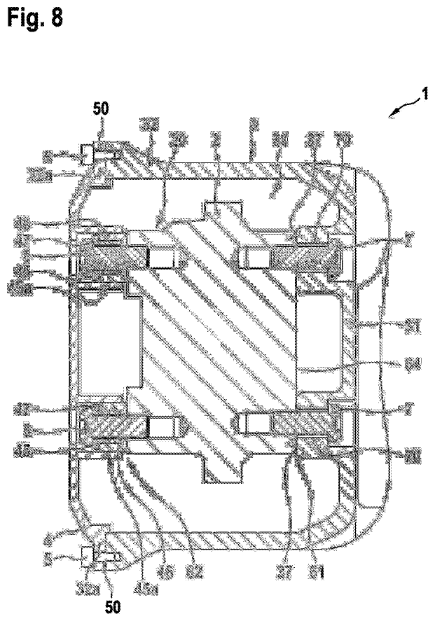

FIG. 8 shows a sectional view of a drive assembly 1 according to a fourth exemplary embodiment of the invention. The fourth exemplary embodiment substantially corresponds to the first exemplary embodiment of FIGS. 1 to 3, with a further alternative design of the holding element 4. FIG. 8 also shows the direct screw connection of the drive unit 2 to the base 31 by means of further screws 7.

In the fourth exemplary embodiment of FIG. 8, the holding element 4 is configured as a lid, which abuts the entire front face 32a of the lateral wall 32. The holding space 30 can thereby be substantially closed by the lid 4, wherein the lid 4 can have a similar recess as the base 31 (cf. FIG. 3).

As in the first exemplary embodiment of FIGS. 1 to 3, in the fourth exemplary embodiment of FIG. 8, the lid 4 is screwed to the lateral wall 32 with first screws 5 and to a holding region 20 of the drive unit 2 with second screws 6.

In addition, the holding element 4 has two openings 45 and, per opening 45, an elastomeric element 46 and a sleeve 47, which are arranged within the corresponding opening 45. The sleeve 47 and the elastomeric element 46 are partially inserted into one another, wherein the elastomeric element 46 is arranged on a side of the sleeve 47 facing the drive unit 2. When tightening the screw 6, the sleeve 47 and the elastomeric element 46 are pushed towards the drive unit 2. The sleeve 47 pushes the elastomeric element 46 against the drive unit 2, in particular until the sleeve 47 comes into contact with the drive unit 2. Due to the elasticity of the elastomeric element 46, it is additionally radially flared by pressing, and it is pressed against an inner side 45a of the opening 45. Thus, the tolerance compensation between the holding element 4, the drive unit 2, and the lateral wall 32 is implemented by the elastomeric element 46 that has been pressed by means of screw 6 and sleeve 47.

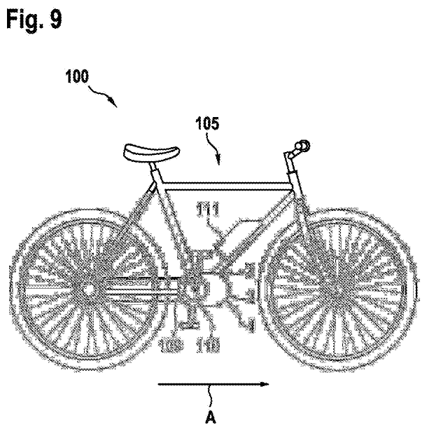

FIG. 9 shows a simplified schematic view of a vehicle 100 which is operated using muscle power and/or a motor and has a drive assembly 1 according to a first exemplary embodiment of the invention. The vehicle 100 is an electric bicycle. The arrow marked with the letter A represents the direction of travel of the electric bicycle. The drive assembly 1 is arranged in the region of a bottom bracket and has a drive unit 2. The drive unit 2 has an electric motor and a transmission, and is provided to support the rider's pedal force generated by muscle power by means of a torque generated by the electric motor. The drive unit 2 is supplied with electrical power by an electrical energy store 111. The drive assembly 1 has a frame interface 3. The frame interface 3 is an integral component of a vehicle frame 105 of the vehicle 100. An output shaft 108 is rotationally fixedly connected to a chainring 109. The bottom bracket axle 110 can be driven on the one hand by the muscle power of the rider and on the other hand by the motor power of the drive unit 2. The direction of travel is marked with the letter A.

1. A drive assembly of a vehicle which is operated using muscle power and/or a motor, comprising:
a drive unit,
a frame interface, and
at least one holding element,
wherein the frame interface is L-shaped and has a base and a lateral wall,
wherein the drive unit is fastened to the base of the L-shaped frame interface via a fixed bearing assembly, and
wherein the holding element is fastened to the lateral wall of the L-shaped frame interface and to the drive unit via a respective floating bearing assembly in each case.

2. The drive assembly according to claim 1, wherein the base of the frame interface is arranged on an output side of the drive unit and is substantially orthogonal to a bottom bracket axle of the drive unit, and the lateral wall is arranged substantially perpendicular to the base.

3. The drive assembly according to claim 1, wherein the fixed bearing assembly is formed in that the base is fastened to at least one threaded bolt of a housing of the drive unit.

4. The drive assembly according to claim 1, wherein the floating bearing assembly is formed in that the holding element is an elastically deformable, plate-shaped element.

5. The drive assembly according to claim 4, wherein the holding element is a planar piece of sheet metal.

6. The drive assembly according to 4, wherein:
the holding element is a stepped piece of sheet metal with two planar sheet portions, and
the two planar sheet portions are arranged parallel to one another with a predefined offset.

7. The drive assembly according to claim 1, wherein the holding element is a lid abutting an end face of the lateral wall of the frame interface.

8. The drive assembly according to claim 7, wherein the lid has at least one opening and, per opening, an elastomeric element and a sleeve, wherein the elastomeric element and the sleeve are arranged in the opening and are fastened to the drive unit by way of a screw such that the sleeve pushes the elastomeric element against the drive unit.

9. The drive assembly according to claim 1, wherein the drive assembly is configured such that, in a fully screwed state, at least one holding region of the drive unit between the holding element and the base of the frame interface is stressed by tension or pressure.

10. The drive assembly according to claim 1, wherein the lateral wall circumferentially completely surrounds the base.

11. The drive assembly according to claim 1, wherein:
the lateral wall has a recess, in particular wherein
the recess extends over at least 20% of the circumference of the lateral wall, and
the recess extends over a maximum of 80% of the circumference of the lateral wall.

12. A vehicle which is operated using muscle power and/or a motor, comprising a drive assembly according to claim 1.

13. The vehicle according to claim 12, further comprising a chassis, wherein:
the frame interface is an integral component of the chassis, and
the frame interface is connected to a lower tube and/or to a seat tube and/or to chain struts of the chassis.

14. The vehicle according to claim 12, wherein the base of the frame interface is arranged on a chainring side of the drive unit.

15. The vehicle according to claim 12, further comprising a spring-loaded chainstay connected to the frame interface in an articulated manner by way of a hinge, wherein the hinge is integrated into the lateral wall of the frame interface.

16. A method for producing a drive assembly of a vehicle, comprising:
arranging a drive unit at least partially in a receiving space of an L-shaped frame interface such that the drive unit abuts a base of the frame interface,
providing a holding element, and
screwing the holding element to a lateral wall of the frame interface and to the drive unit,
wherein the holding element is screwed to the drive unit and the lateral wall such that, in a fully screwed state, at least one holding region of the drive unit between the holding element and the base of the frame interface is stressed by tension or pressure.

17. The method according to claim 16, further comprising:
producing the frame interface by die-casting,
generating screw openings in the frame interface, and
generating support points on the base of the frame interface,
wherein the screw openings and the support points are generated by way of machining.

18. The drive assembly according to claim 1, wherein the fixed bearing assembly is formed in that the base is fastened to a threaded screw of a housing of the drive unit.

19. The drive assembly according to claim 1, wherein the fixed bearing assembly is formed in that the base is fastened to a threaded sleeve of a housing of the drive unit.

20. The vehicle according to claim 12, wherein the vehicle is an electric bicycle.
